(19) United States
(12) Patent Application Publication
(10) Pub. No.: US 2020/0180972 A1
(43) Pub. Date: Jun. 11, 2020

(54) NOVEL TRIALUMINUM HYDROXY CHLORIDE OF FORMULA AL3(OH)4CL5 AND PROCESS FOR THE PREPARATION THEREOF FROM INDUSTRIAL WASTE

(71) Applicant: Nareshkumar Ishwarlal Nagar, Ahmedabad (IN)

(72) Inventor: Nareshkumar Ishwarlal Nagar, Ahmedabad (IN)

(21) Appl. No.: 16/608,661

(22) PCT Filed: Mar. 23, 2018
(86) PCT No.: PCT/IN2018/050162

§ 371 Date: Oct. 25, 2019

(30) Foreign Application Priority Data
Mar. 27, 2017 (IN) 201721010656

(51) Int. Cl. C01F 7/30

(52) U.S. Cl. CPC C01F 7/30

(57) ABSTRACT

The present invention relates to novel Tri Aluminum Hydroxy chloride of the formula Al₃(OH)₄Cl₅. The present invention also relates to a process for the preparation of Tri Aluminum Hydroxy chloride of the formula Al₃(OH)₄Cl₅ from industrial waste wherein the industrial waste is obtained from the chemical reactions, the reactions using anhydrous aluminum chloride as acid catalyst, for example Friedel-Craft reactions. The product of the formula Al₃(OH)₄Cl₅ is obtained in an aqueous solution form from the industrial waste.

### FIELD OF THE PRESENT INVENTION

The present invention relates to novel Tri Aluminum Hydroxy chloride of formula Al₃(OH)₄Cl₅.

The present invention also relates to a process for the preparation of Tri Aluminum Hydroxy chloride of formula Al₃(OH)₄Cl₅ from Industrial wastes wherein industrial waste obtained from the chemical reactions, the reactions using anhydrous aluminium chloride as Acid Catalyst for example friedel-craft reactions. The product of formula Al₃(OH)₄Cl₅ is obtained in an aqueous solution form from the industrial waste.

The solution thus obtained, has diversified usages for example it is used in paper sizing industry, as flocculating agent and in the manufacture of aluminium hydroxide powder.

### BACKGROUND OF THE INVENTION

Aluminium chloride is used as lewis acid catalyst in the friedel-craft reactions, such reactions are used in manufacture of dyes and dyes intermediates, bulk drug or active pharmaceutical ingredients, chemicals and their intermediates for example but not limited to m-phenoxybenzaldehyde, acetyl yarayara, 2,4,6-Trimethyl Benzoyl Chloride, pigment green-7, copper phthalocynine green-7, pentamethylindane, alfa-alfa-dimethyl phenyl acetic acid methyl ester, (4-cyclopropyl-oxo-methyl)-(alpha, alpha dimethyl) phenyl ethyl acetate.

Industrial hazardous wastes came out after the completion of the reaction is too hazardous and harmful to human beings, animals, environment and for water too.

In well-known processes, such as paraffin isomerization, in which aluminum halide catalysts, such as aluminum chloride, are used in conjunction with a support, such as bauxite, alumina, clays, and the like, the catalyst gradually becomes deactivated with use and must be replaced. It is theorized that during the reaction the aluminum halide becomes complexed with hydrocarbon and is thus rendered ineffective for the intended purpose. It is clear that the spent catalyst does not contain aluminum halide in its original form, since paraffin conversion ceases and hydrocarbon washing will not remove the aluminum halide there from, though pure aluminum halide is quite soluble in hydrocarbons. For the sake of clarity the aluminum halide in the spent catalyst will be referred to as the aluminum halidehydrocarbon complex,

In any event, the mass of support and aluminum halidehydrocarbon complex presents problems whether one is discarding it or attempting to recover the support there from. The fouled catalyst mass is extremely corrosive and if dumped will cause air contamination for exposure to air and moisture results in the liberation of toxic hydrogen halide. Disposal by dumping in water further creates a pollution and safety problem because of the evolution of HBr or HCl during the hydrolysis and the gelatinous nature of the aluminum hydroxide.

There are number of references available in which polymetal hydroxy chlorides have been reported.

EP0063812B1 dated Apr. 26, 1982 of Prodeco S.P.A. has disclosed Trialuminium hydroxy chloride having the general formula Aln(OH)mCl3n-m, wherein m is a number smaller than 3n and the ratio is at least 2, preferably 5, for use as a size precipitant in paper making.

U.S. Pat. No. 4,051,028 dated Apr. 26, 1976 of Degremont has disclosed a process for the purification of water containing dissolved and/or suspended material which comprises adding thereto a polymeric aluminum hydroxide solution prepared by treating slowly and under vigorous agitation a solution containing up to 2.5 moles/liter of an aluminum salt with a solution containing an amount of an alkaline or alkaline-earth hydroxide such that in the resulting solution the molar ratio of hydroxide to aluminum is from 2.3 to 2.7 and the concentration of aluminum is from 0.025 to 0.40 mole/liter. The polymeric aluminum hydroxide can be represented by the general formula Alp(OH)qr+ wherein p is generally from 10 to 54 and q from 30 to 150 and r=3p−q, whereas polymeric Tri aluminum hydroxy solution according to the invention can be represented in the following manner:

n[AlX₃(Me1/vOH)m]×H₂O

n representing the final concentration of Al in moles/l and being a value between 0.025 and 0.040 mole/l,

m being the molar ratio OH/Al,

Me being an alkaline or alkaline-earth cation,

v being the valence of Me,

X being a monovalent anion, for example chlorine, and

x being the number of molecules of water in the solution.

It is to be noted that no prior art has suggested a compound of formula Al₃(OH)₄Cl₅.

Yet it is an hourly need to provide novel Tri Aluminium hydroxy chloride of formula Al₃(OH)₄Cl₅ and a process for the preparation of the compound of formula Al₃(OH)₄Cl₅ that has tremendous industrial applications for example it may be used as paper sizing material, flocculating agent or in the treatment of industrial wastes or in the treatment of industrial water too.

Further, it is also required to provide a process for recycling industrial waste that helps in minimizing air and water pollution by decreasing the volume of the industrial waste.

### OBJECTS OF THE PRESENT INVENTION

The principal object of the present invention is to fulfill the requirement and the goals as shown in the preceded paragraphs.

There is also an object of the present invention to provide compound of formula Al₃(OH)₄Cl₅.

It is yet an object of the present invention to provide safe, industry viable process for the preparation of Tri Aluminium hydroxy chloride of formula Al₃(OH)₄Cl₅.

It is an object to provide a process for the preparation an aqueous solution of compound of formula Al₃(OH)₄Cl₅ from industrial wastes.

### BRIEF DESCRIPTION OF DRAWINGS

FIG. 1 is a flow-diagram for the preparation of Tri Aluminum Hydroxy chloride from industrial waste obtained from friedel-craft reactions other than CPC green manufacturing.

FIG. 2 is a flow-diagram for the preparation of Tri Aluminum Hydroxy chloride from industrial waste obtained from CPC green manufacturing industries.

### DETAILED DESCRIPTION OF THE INVENTION

Thus, the present invention is directed to a novel compound “Tri Aluminum Hydroxy chloride” of formula Al₃(OH)₄Cl₅. Further, the present invention is also directed to a process for the preparation of compound of formula Al₃(OH)₄Cl₅ from industrial waste obtained from aluminium chloride (AlCl₃) aided friedel-craft reactions.

Tri Aluminum Hydroxy Chloride monomer of formula Al₃(OH)₄Cl₅ is also known as Aluminum Hydroxide Chloride (AHC), Tri Aluminum Tetra Hydroxyl Penta Chloride, Basic Aluminum Chloride, Aluminum Penta Chloro Hydroxide, or Aluminum Tetrahydroxy Chloride. Aluminium chloride is used as lewis acid catalyst in the friedel-craft reactions, such reactions are used in manufacture of dyes and dyes intermediates, bulk drug or active pharmaceutical ingredients, chemicals and their intermediates for example but not limited to m-phenoxybenzaldehyde, acetyl yarayara, 2,4,6-Trimethyl Benzoyl Chloride, phthalocynine green, copper phthalocynine green-7, pentamethylindane, alfa-dimethyl phenyl acetic acid methyl ester.

The industrial waste obtained from the friedel-craft reactions is highly acidic and also called as spent aluminium chloride solution as spent mainly contains aluminium chloride. Apart from Aluminum chloride, there are also heavy metals such as mercury, cadmium, arsenic, lead, iron, zinc, copper, chromium, manganese present in spent. Further, industrial waste also contains unreacted raw materials, starting materials or impurities formed during the reaction.

According to the first aspect, there is provided a monomer compound of formula Al₃(OH)₄Cl₅.

Preferably, the compound of formula Al₃(OH)₄Cl₅ is obtained in aqueous solution.

According to the second aspect, there is provided a process for the preparation of compound of formula Al₃(OH)₄Cl₅ from industrial waste.

A process for the preparation of Tri Aluminum Hydroxy chloride of formula Al₃(OH)₄Cl₅ from industrial waste obtained from aluminium chloride aided friedel-craft reactions, the process comprises:
(i) diluting spent aluminium chloride solution with addition of water into it;
(ii) reacting step-i with aluminium hydroxide or alumina and base at a temperature between 25° C. to 40° C.;
(iii) Stirred the reaction mixture between 25° C. to 40° C. till get the clear solution;
(iv) optionally adding iron scrap into the above mixture under stirring at a temperature between 25° C. to 40° C.;
(v) filtering the reaction mixture & washing it with water to get the aqueous solution of Tri Aluminum Hydroxy chloride of formula Al₃(OH)₄Cl₅.

Spent obtained after the completion of friedel-craft reaction is acidic in nature and it mainly contains moist aluminium chloride, calcium chloride, sodium chloride as V-salt, heavy metals and unreacted organic compounds used in the reaction.

Moist aluminium chloride ratio in the spent is between 10% to 30% while moisture in the spent may varied between 70% to 90%.

The presence of the other salts such as calcium chloride and sodium chloride as V-salt depend on the friedel-craft reaction taken place, the sum of the total quantity of calcium chloride and sodium chloride may be varied between 3% to 30%.

Total heavy metals present in the spent depend on the catalyst, raw materials, starting materials or the combination thereof used in the friedel-craft reaction. In general and preferably, spent contains heavy metals such as but not limited to mercury, cadmium, arsenic, lead, iron, zinc, copper, chromium, manganese and the sum of quantity of all heavy metals is varied between 1-1000 mg/kg.

In case of CPC green manufacturing, cuprous chloride (CuCl₃) is used in the reaction hence spent or industrial waste also contains copper as the second major ingredient which if desirous, may be isolated as bi-product during the preparation of Tri Aluminum Hydroxy chloride of formula Al₃(OH)₄Cl₅.

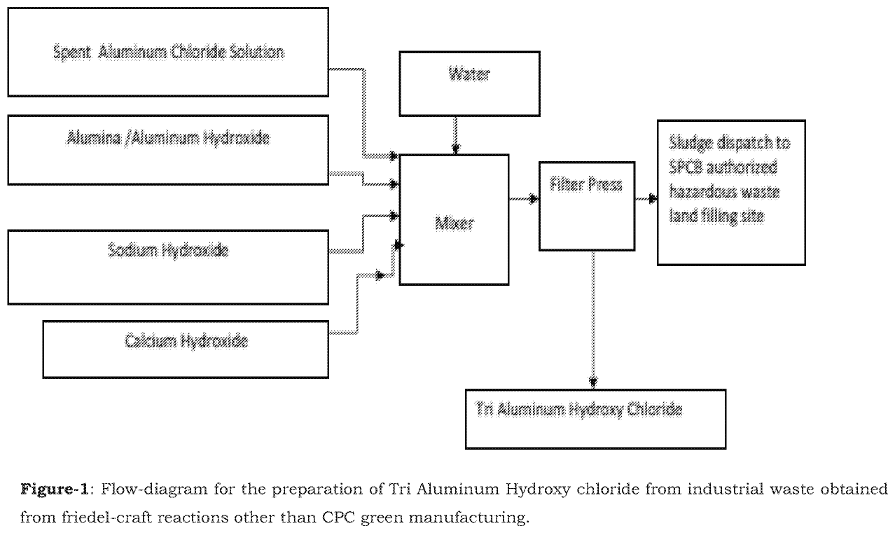

FIG. 1 has shown a flow-diagram for the preparation of Aluminum Hydroxide chloride from industrial waste obtained from friedel-craft reactions other than CPC green manufacturing.

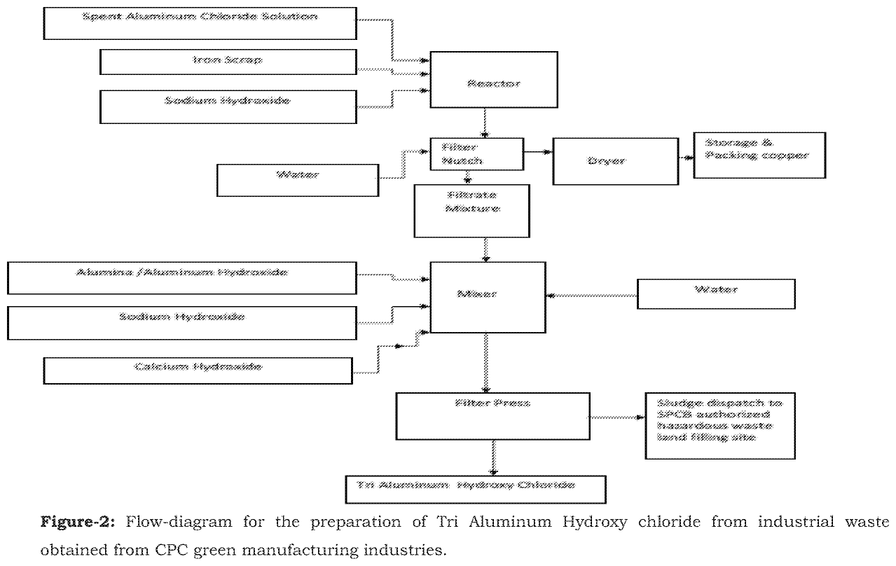

FIG. 2 has shown a flow-diagram for the preparation of Tri Aluminum Hydroxy chloride from industrial waste obtained from CPC green manufacturing industries.

A process for the preparation of Tri Aluminum Hydroxy chloride of formula Al₃(OH)₄Cl₅ may now be described as follows:

Spent aluminium chloride solution obtained from friedel-craft reaction is taken for preparation of aqueous Tri Aluminum Hydroxy chloride solution.

Accordingly, In a reactor, a certain amount of water is added into spent aluminium chloride solution and stirred at a temperature between 25° C. to 40° C. Alumina (Al₂O₃) or Aluminium hydroxide (Al(OH)₃) is added into the above precursor/mixture under stirring.

At least one base is added into the said mixture and stirred till the precursor/mixture turned into the clear solution. Addition of the base make the reaction exothermic hence while adding the base into the mixture, it is required to control the temperature of the reaction between 25° C. to 40° C. using the methods known in the art. Once the clear solution is obtained, calcium hydroxide (Ca(OH)₂) is added into it and stirred at the same temperature for half an hour. The mixture then taken for nutch filtration using filter press. The solution contains Tri Aluminum Hydroxy chloride product of formula Al₃(OH)₄Cl₅.

Reaction equation for preparation of Tri Aluminum Hydroxy chloride of formula Al₃(OH)₄Cl₅ is provided as follows:

4Al(OH)₃+5AlCl₃→3Al₃(OH)₄Cl₅

OR

3AlCl₃+Ca(OH)₂+2NaOH→Al₃(OH)₄Cl₅+CaCl₂+2NaCl

The aqueous solution of Tri Aluminum Hydroxy chloride of formula Al₃(OH)₄Cl₅ thus obtained, contains Tri Aluminum Hydroxy chloride quantity between 9% to 30% w/v.

In case of CPC green manufacturing, cuprous chloride (CuCl₃) is used in the friedel-craft reaction hence spent or industrial waste also contains copper as the second major ingredient. While using CPC green spent instead of the above spent, optionally iron ore is added in the reaction mixture and copper may be isolated as bi-product during the preparation of Tri Aluminum Hydroxy chloride of formula Al₃(OH)₄Cl₅.

The amount or ratio of the raw materials/water/reactants used in the reaction to obtain 1 kg of finished Al₃(OH)₄Cl₅ solution is provided as follows:

Spent Aluminium chloride solution: between 85% to 95% compare to the finished Al₃(OH)₄Cl₅ solution.

Alumina (Al₂O₃)/Aluminum Hydroxide {Al(OH)₃}: 0.03% to 0.05%

Water: between 1% to 5%

Base: between 5% to 10%

Base is selected from metal hydroxides, metal carbonates, metal bicarbonates or combination thereof for example but not limited to NaOH, Na₂Co₃, Ca(OH)₂, NaHCO₃ etc.

The quantities mentioned above is taken based on the preparation of 1 kg finished Al₃(OH)₄Cl₅ solution. Further, it is also possible to commercialize and mass produce the finished Al₃(OH)₄Cl₅ solution by calculating the ratio of each material/chemical provided above.

Analysis of the process for the preparation of Tri Aluminium hydroxy chloride of formula Al₃(OH)₄Cl₅ is done using the analytical methods such as Atomic absorption spectrophotometer, ion chromatograph while identification of Organic Impurities done by Gas Chromatograph MS.

The present invention demonstrated examples cited below, which are provided as illustration only and therefore should not be construed as limitation of the possible and future invention.

Analysis of the Spent and Finished Product:

All the raw materials, Spent AlCl₃ obtained from the industry, finished Al₃(OH)₄Cl₅ solution sent for analysis at Pollucon Laboratories Pvt. Ltd.

Below Results i.e. (i) before process & (ii) after process for each experimental example are obtained from the samples sent to Pollucon Laboratories Pvt. Ltd, Surat, Gujarat, India.

Pollucon Laboratories Pvt. Ltd. is recognized by MOEE, New Delhi under section 12 of Environmental Protection Act-1986 and acting as environmental auditors, consultants & analysts.

### EXAMPLES OF THE INVENTION: PROCESS FOR THE PREPARATION OF TRI ALUMINUM HYDROXY CHLORIDE OF FORMULA Al₃(OH)₄Cl₅

### Example-1: From Spent Aluminum Chloride Solution Generated from AcetylYaraYara Manufacturing

Before the Process: Characteristics of Spent Aluminium Chloride Solution:

| | | | Present |
|---|---|---|---|
| | | | in Spent/ |
| Sr. | | | Industrial |
| No. | Parameters | Unit | Waste |
| 1 | Moisture | % | 69.19 |
| 2 | Aluminium Chloride | % | 28.18 |
| | as AICI₃ | | |
| 3 | HCL@ | % | 1.40 |
| 4 | V-salt (Sodium Chloride) | % | 1.20 |

Heavy Metals

| | | | |
|---|---|---|---|
| 5 | Mercury as Hg | mg/kg | <0.1 |
| 6 | Arsenic as As | mg/kg | <0.1 |
| 7 | Cadmium as Cd | mg/kg | 0.06 |
| 8 | Lead as Pb | mg/kg | 0.39 |
| 9 | Iron as Fe | mg/kg | 6.6 |
| 10 | Zinc as Zn | mg/kg | 0.57 |
| 11 | Copper as Cu | mg/kg | 0.68 |
| 12 | Chromium as Cr | mg/kg | 0.45 |
| 13 | Manganese as Mn | mg/kg | 0.58 |

Organic Compound

| | | | |
|---|---|---|---|
| 14 | Nitro benzene | mg/kg | 10.8 |
| 15 | 2- mithoxy naphthalene | mg/kg | 0.67 |
| 16 | 2 acetyl 6 | mg/kg | 53.55 |
| | methoxyNepthelene | | |
| 17 | Acetyl Chloride | mg/kg | 4.1 |

@HCI (based on remaining chlorine after deduction from total chlorine)

After the Process: Characteristics of Tri Aluminium Hydroxy Chloride Solution:

| | | | In |
|---|---|---|---|
| | | | Aluminium |
| Sr. | | | Hydroxide |
| No. | Parameters | Unit | Chloride |
| 1 | Moisture | % | 67.20 |
| 2 | Aluminium | % | 22.72 |
| | Hydroxide Chloride | | |
| 3 | HCL@ | % | <0.01 |
| 4 | V-salt (as Sodium Chloride) | % | 5.20 |
| 5 | Calcium Chloride | % | 4.80 |

Heavy Metals

| | | | |
|---|---|---|---|
| 6 | Mercury as Hg | mg/kg | <0.1 |
| 7 | Arsenic as As | mg/kg | <0.1 |
| 8 | Cadmium as Cd | mg/kg | 0.04 |
| 9 | Lead as Pb | mg/kg | 0.13 |
| 10 | Iron as Fe | mg/kg | 0.3 |
| 11 | Zinc as Zn | mg/kg | 0.23 |
| 12 | Copper as Cu | mg/kg | 0.12 |
| 13 | Chromium as Cr | mg/kg | 0.19 |
| 14 | Manganese as Mn | mg/kg | 0.02 |

Organic Compound

| | | | |
|---|---|---|---|
| 15 | Nitro benzene | mg/kg | 5.73 |
| 16 | 2- mithoxy naphthalene | mg/kg | 0.03 |
| 17 | 2 acetyl 6 methoxy | mg/kg | 4.84 |
| | Nepthelene | | |
| 18 | Acetyl Chloride | mg/kg | 3.2 |

@HCI (based on remaining chlorine after deduction from total chlorine)

### Example-2: From Spent Aluminum Chloride Solution Generated from Fex-10 (4-(Cyclopropyl-Oxo-Methyl)-Alpha,Alpha Dimethyl Phenyl Ethyl Acetate Manufacturing Industries

Before the Process: Characteristics of Spent Aluminium Chloride Solution:

| | | | Present |
|---|---|---|---|
| | | | in Spent/ |
| Sr. | | | Industrial |
| No. | Parameters | Unit | Waste |
| 1 | Moisture | % | 76.33 |
| 2 | Aluminium Chloride | % | 21.70 |
| | as AICI₃ | | |
| 3 | HCL@ | % | 1.10 |
| 4 | V-salt (as Sodium Chloride) | % | 0.40 |

Heavy Metals

| | | | |
|---|---|---|---|
| 5 | Mercury as Hg | mg/kg | <0.1 |
| 6 | Arsenic as As | mg/kg | <0.1 |
| 7 | Cadmium as Cd | mg/kg | 0.01 |
| 8 | Lead as Pb | mg/kg | 8.29 |
| 9 | Iron as Fe | mg/kg | 38.48 |
| 10 | Zinc as Zn | mg/kg | 6.98 |
| 11 | Copper as Cu | mg/kg | 3.48 |
| 12 | Chromium as Cr | mg/kg | 1.52 |
| 13 | Manganese as Mn | mg/kg | 9.20 |

Organic Compound

| | | | |
|---|---|---|---|
| 14 | Benzene | mg/kg | 0.02 |
| 15 | 2- methyl prop 2 ethyl | mg/kg | 1.01 |
| | acetate | | |
| 16 | Methylene Chloride | mg/kg | 18.5 |
| 17 | 2,2- dimethyl phenyl ethyl | mg/kg | 1.06 |
| | acetae | | |
| 18 | 4, chlorobutyl chloride | mg/kg | <0.1 |

@HCI (based on remaining chlorine after deduction from total chlorine)

After Process: Characteristics of Tri Aluminum Hydroxy Chloride as Finished Product:

| | | | In |
|---|---|---|---|
| | | | Aluminium |
| Sr. | | | Hydroxide |
| No. | Parameters | Unit | Chloride |
| 1 | Moisture | % | 71.80 |
| 2 | Aluminium | % | 17.70 |
| | Hydroxide Chloride | | |
| 3 | HCL@ | % | <0.01 |
| 4 | V-salt (as Sodium Chloride) | % | 5.14 |
| 5 | Calcium Chloride | % | 5.28 |

Heavy Metals

| | | | |
|---|---|---|---|
| 6 | Mercury as Hg | mg/kg | <0.1 |
| 7 | Arsenic as As | mg/kg | <0.1 |
| 8 | Cadmium as Cd | mg/kg | 0.005 |
| 9 | Lead as Pb | mg/kg | 3.84 |
| 10 | Iron as Fe | mg/kg | 26.91 |
| 11 | Zinc as Zn | mg/kg | 5.21 |
| 12 | Copper as Cu | mg/kg | 2.78 |
| 13 | Chromium as Cr | mg/kg | 0.99 |
| 14 | Manganese as Mn | mg/kg | 7.90 |

Organic Compound

| | | | |
|---|---|---|---|
| 14 | Benzene | mg/kg | <0.1 |
| 15 | 2- methyl prop 2 ethyl | mg/kg | 0.43 |
| | acetate | | |
| 16 | Methylene Chloride | mg/kg | 12.5 |
| 17 | 2,2- dimethyl phenyl | mg/kg | 0.85 |
| | ethyl acetae | | |
| 18 | 4, chlorobutyl chloride | mg/kg | <0.1 |

@HCI (based on remaining chlorine after deduction from total chlorine)

### Example-3: From Spent Aluminum Chloride Solution Generated from Penta Methyl Indane (Intermediate Stage) Manufacturing Industries

Before the Process: Characteristics of Spent Aluminium Chloride Solution:

| | | | Present |
|---|---|---|---|
| | | | in Spent/ |
| Sr. | | | Industrial |
| No. | Parameters | Unit | Waste |
| 1 | Moisture | % | 69.40 |
| 2 | Aluminium Chloride | % | 28.70 |
| | as AICI₃ | | |
| 3 | HCL^{@} | % | 1.80 |
| 4 | V-salt (as Sodium Chloride) | % | 0.04 |

Heavy Metals

| | | | |
|---|---|---|---|
| 5 | Mercury as Hg | mg/kg | <0.1 |
| 6 | Arsenic as As | mg/kg | <0.1 |
| 7 | Cadmium as Cd | mg/kg | 0.08 |
| 8 | Lead as Pb | mg/kg | 0.75 |
| 9 | Iron as Fe | mg/kg | 6.20 |
| 10 | Zinc as Zn | mg/kg | 1.06 |
| 11 | Copper as Cu | mg/kg | 1.04 |
| 12 | Chromium as Cr | mg/kg | 0.81 |
| 13 | Manganese as Mn | mg/kg | 0.78 |

Organic Compound

| | | | |
|---|---|---|---|
| 14 | Propeleneoxide | mg/kg | <0.1 |
| 15 | Di chloromethane | mg/kg | 0.021 |

@HCI (based on remaining chlorine after deduction from total chlorine)

After the Process: Characteristics of Tri Aluminum Hydroxy Chloride as Finished Product:

| | | | In |
|---|---|---|---|
| | | | Aluminium |
| Sr. | | | Hydroxide |
| No. | Parameters | Unit | Chloride |
| 1 | Moisture | % | 66.4 |
| 2 | Aluminium | % | 23.20 |
| | Hydroxide Chloride | | |
| 3 | HCL@ | % | <0.01 |
| 4 | V-salt (as Sodium Chloride) | % | 5.30 |
| 5 | Calcium Chloride | % | 4.90 |

Heavy Metals

| | | | |
|---|---|---|---|
| 6 | Mercury as Hg | mg/kg | <0.1 |
| 7 | Arsenic as As | mg/kg | <0.1 |
| 8 | Cadmium as Cd | mg/kg | 0.04 |
| 9 | Lead as Pb | mg/kg | 0.37 |
| 10 | Iron as Fe | mg/kg | 3.0 |
| 11 | Zinc as Zn | mg/kg | 0.46 |
| 12 | Copper as Cu | mg/kg | 0.29 |
| 13 | Chromium as Cr | mg/kg | 0.19 |
| 14 | Manganese as Mn | mg/kg | 0.06 |

Organic Compound

| | | | |
|---|---|---|---|
| 15 | Propeleneoxide | mg/kg | <0.1 |
| 16 | Di chloromethane | mg/kg | 0.007 |

@HCI (based on remaining chlorine after deduction from total chlorine)

### Example-4: From Spent Aluminum Chloride Solution Generated from CPC Green Manufacturing Industries

Before Process: Characteristics of Spent Aluminium Chloride Solution:

| | | | Present |
|---|---|---|---|
| | | | in Spent/ |
| Sr. | | | Industrial |
| No. | Parameters | Unit | Waste |
| 1 | Moisture | % | 84.10 |
| 2 | Aluminium Chloride | % | 11.52 |
| | as AICI₃ | | |
| 3 | HCL@ | % | 1.60 |
| 4 | V-salt (as Sodium Chloride) | % | 1.40 |
| 5 | Cuppers Chloride as | % | 0.614 |
| | CuCl₃ | | |

Heavy Metals

| | | | |
|---|---|---|---|
| 6 | Mercury as Hg | mg/kg | <0.1 |
| 7 | Arsenic as As | mg/kg | <0.1 |
| 8 | Cadmium as Cd | mg/kg | 0.12 |
| 9 | Lead as Pb | mg/kg | 4.90 |
| 10 | Iron as Fe | mg/kg | 1947 |
| 11 | Zinc as Zn | mg/kg | 29.53 |
| 12 | Copper as Cu | mg/kg | 2296 |
| 13 | Chromium as Cr | mg/kg | 1.09 |
| 14 | Manganese as Mn | mg/kg | 19.22 |
| 15 | Ferric Chloride | mg/kg | 5654 |

Organic Compound

| | | | |
|---|---|---|---|
| 16 | CPC- Blue | mg/kg | 7.40 |
| 17 | CPC- Green | mg/kg | 8.80 |

@HCI (based on remaining chlorine after deduction from total chlorine)

After the Process: Characteristics of Tri Aluminum Hydroxy Chloride as Finished Product:

| | | | In |
|---|---|---|---|
| | | | Aluminium |
| Sr. | | | Hydroxide |
| No. | Parameters | Unit | Chloride |
| 1 | Moisture | % | 79.90 |
| 2 | Aluminium | % | 9.30 |
| | Hydroxide Chloride | | |
| 3 | HCL@ | % | <0.01 |
| 4 | V-salt (as Sodium Chloride) | % | 5.4 |
| 5 | Calcium Chloride | % | 4.8 |
| 6 | Cuppers Chloride as | % | 123 |
| | CuCl₃ | | |

Heavy Metals

| | | | |
|---|---|---|---|
| 7 | Mercury as Hg | mg/kg | <0.1 |
| 8 | Arsenic as As | mg/kg | <0.1 |
| 9 | Cadmium as Cd | mg/kg | 0.086 |
| 10 | Lead as Pb | mg/kg | 3.1 |
| 11 | Iron as Fe | mg/kg | 84.42 |
| 12 | Zinc as Zn | mg/kg | 36.8 |
| 13 | Copper as Cu | mg/kg | 46.04 |
| 14 | Chromium as Cr | mg/kg | 0.82 |
| 15 | Manganese as Mn | mg/kg | 8.19 |
| 16 | Ferric Chloride | mg/kg | 245 |

Organic Compound

| | | | |
|---|---|---|---|
| 17 | CPC- Blue | mg/kg | <5 |
| 18 | CPC- Green | mg/kg | <5 |

@HCI (based on remaining chlorine after deduction from total chlorine)

Copper as Bi-Product from CPC Green Spent:

| Sr. | | Result |
|---|---|---|
| No. | Parameters | (%) |
| 1 | Moisture (By KF) | 9.00 |
| 2 | Copper as Cu | 88.40 |
| 3 | Fe₂O₃ | 2.60 |

While the invention has been described and exemplified in sufficient detail for those skilled in this art to make and use it, various alternatives, modifications, and improvements should be apparent without departing from the spirit and scope of the invention.

One skilled in the art readily appreciates that the present invention is well adapted to carry out the objects and obtain the ends and advantages mentioned, as well as those inherent therein. It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations, which are not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Other embodiments are set forth within the following claims.

I/We claim:

1. A monomer compound “Tri Aluminum Hydroxy chloride” of formula Al₃(OH)₄Cl₅.

2. A compound of formula Al₃(OH)₄Cl₅ as claimed in claim-1 is obtained as aqueous solution.

3. A compound of formula Al₃(OH)₄Cl₅ as claimed in claim-2 wherein quantity of Al₃(OH)₄Cl₅ in water is between 9% to 30%.

4. The process for the preparation of Tri Aluminum Hydroxy chloride of formula Al₃(OH)₄Cl₅ from industrial waste obtained from aluminium chloride aided friedel-craft reactions, the process comprises:
i. diluting spent aluminium chloride solution with addition of water into it;
ii. reacting step-i with aluminium hydroxide or alumina and base at a temperature between 25° C. to 40° C.;
iii. Stirred the reaction mixture between 25° C. to 40° C. till get the clear solution;
iv. optionally adding iron scrap into the above mixture under stirring at a temperature between 25° C. to 40° C.;
v. filtering the reaction mixture & washing it with water to get the aqueous solution of Tri Aluminum Hydroxy chloride of formula Al₃(OH)₄Cl₅.

5. The process as claimed in claim-4 wherein the ratio of moist AlCl₃ in industrial waste is between 10% to 30%.

6. The process as claimed in claim-4 wherein the quantity of Al(OH)₃ or Alumina is between 0.03% to 0.05%.

7. The process as claimed in claim-4 wherein base is selected from metal hydroxides, metal carbonates, metal bicarbonates or combination thereof.

8. The process as claimed in claim-4 wherein the quantity of base is between 5% to 10%.

9. The process as claimed in claim-4 wherein the quantity of water for diluting spent is between 1% to 5%.

10. The process as claimed in claim-4 wherein if spent AlCl₃ is taken from CPC green industrial waste, Copper powder is obtained as byproduct.

11. The process as claimed in claim-4 wherein the quantity of Al₃(OH)₄Cl₅ in water is between 9% to 30%.
